(19) United States
(12) Patent Application Publication
(10) Pub. No.: US 2007/0168607 A1
(43) Pub. Date: Jul. 19, 2007

(54) Storage device using nonvolatile cache memory and control method thereof

(75) Inventors: Yoriharu Takai, Kodaira-shi (JP); Kenji Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/640,312

(22) Filed: Dec. 18, 2006

(30) Foreign Application Priority Data
Jan. 17, 2006 (JP) 2006-009044

(51) Int. Cl. G06F 12/00

(52) U.S. Cl. 711/113; 711/4

(57) ABSTRACT

In a storage device, the data process can be performed without lowering the data processing efficiency even when the sector length of the host device side and the sector length of the hard disk side are different from each other. Partial data or whole data of a second data block using a long sector defined on the hard disk side as a base and surrounding the starting end and terminating end addresses of a first data block using a host-defined sector as a base is read from the hard disk and written to the flash memory before the data process using the flash memory as a cache is performed based on a command.

### CROSS-REFERENCE TO RELATED APPLICATIONS

This application is based upon and claims the benefit of priority from Japanese Patent Application No. 2006-009044, filed Jan. 17, 2006, the entire contents of which are incorporated herein by reference.

### BACKGROUND

1. Field

One embodiment of the invention relates to a storage device using a nonvolatile cache memory and a control method thereof which are designed to realize a high-speed write operation, low power consumption and long service life of a storage medium and enhance the reliability of a data process.

2. Description of the Related Art

In recent years, a storage device on which both of a memory card which is a semiconductor storage medium and a hard disk (HD) drive using a hard disk which is a magnetic storage medium can be mounted is developed (refer to Jpn. Pat. Appln. KOKAI Publication No. 2004-055102). For example, data of the memory card fetched from the exterior can be backed up to the hard disk (HD) which is a magnetic storage medium. Further, data of the hard disk (HD) can be transferred to a memory card and can thus be taken out.

As a mobile storage device, a storage device using a flash memory is developed (refer to Japanese Patent Publication No. 3407317). A large number of errors occur in the flash memory when the number of erase operations of the flash memory becomes large (for example, 100,000 times), and therefore, an attempt is made to solve the above problem. For example, a data management method for suppressing the number of erase operations only for a specified area from becoming larger is provided.

### BRIEF SUMMARY OF THE INVENTION

An object of the embodiments of the present invention is to provide a storage device using a nonvolatile cache memory to create an environment in which the low power consumption and high-speed read/write operation can be realized and the data processing efficiency can be enhanced by skillfully utilizing the features of a semiconductor memory and hard disk used as storage media and a control method thereof.

Particularly, an object of the present embodiment is to provide a storage device using a nonvolatile cache memory which can enhance the reliability of data by using a command which can forcibly determine a data storage destination according to the data access frequency and the state of a cache memory used and a control method thereof.

According to one aspect of the present invention, there is provided an apparatus (a storage device) comprising a host interface, a command analyzing section which analyzes the contents of a command input from the host interface, and a write processing section which transfers write data to a hard disk when a command analyzed by the command analyzing section specifies the hard disk as a data write destination.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the whole configuration of one embodiment according to this invention.

FIG. 2 is a diagram for illustrating the feature of a flash memory shown in FIG. 1.

FIG. 3 is a diagram for illustrating the functions of a flash memory interface and controller 311 shown in FIG. 1.

FIG. 4 is a flowchart for illustrating one example of the operation of a device shown in FIG. 1.

FIG. 5 is a flowchart for illustrating an example of the operation when a host device issues a command.

FIG. 6 is a flowchart for illustrating the operation when the power supply of the device of the present embodiment is turned ON.

### DETAILED DESCRIPTION

Various embodiments according to the invention will be described hereinafter with reference to the accompanying drawings.

<Whole Configuration and Function>

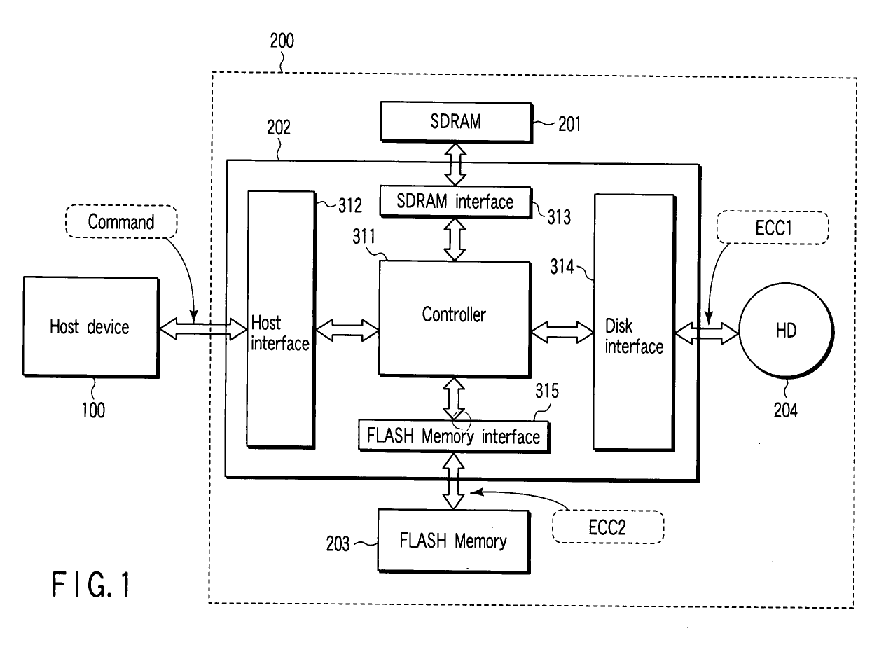

First, one example of a whole block of one embodiment is explained with reference to FIG. 1. A reference symbol 100 denotes a host device which is a control section in a personal computer, for example. A reference symbol 200 denotes a storage device using a nonvolatile cache memory. The storage device 200 includes an SDRAM 201 functioning as a buffer, for example, one-chip large-scale integrated (LSI) circuit 202 on which a controller and the like which will be described later are mounted, flash memory 203, and hard disk (HD) 204. The flash memory 203 may be referred to as a nonvolatile cache memory.

The LSI 202 includes a controller 311, host interface 312, SDRAM interface 313, disk interface 314 and flash memory interface 315. The SDRAM 201 may be contained in the LSI 202.

The host device 100 can supply a command to the controller 311 via the host interface 312. Further, the host device 100 can receive data from the controller 311 via the host interface 312 and transfer data to the controller 311 side.

Commands used by the host device 100 and controller 311 contain a data write command, data readout command, data size specifying command, data transferring command, data storing command and a command for reading out information from a memory. The controller 311 interprets the command from the host device 100 and performs the data write process, read process, transfer process and the like.

The controller 311 can transfer data with respect to the SDRAM 201 via the SDRAM interface 313. Further, the controller 311 can transfer data with respect to the hard disk (HD) 204 via the disk interface 314. In addition, the controller 311 can transfer data with respect to the flash memory 203 via the flash memory interface 315. Data to be stored in the flash memory 203 is stored therein after an error correcting code is added thereto. Also, data to be stored in the hard disk is stored therein after an error correcting code (ECC) is added thereto. Thus, an error correcting code (ECC) process is performed with respect to recording data in the flash memory and recording data on the hard disk so that an error correcting process can be performed at the reproduction time.

In the above device, portions of the flash memory interface 315 and flash memory 203 are used as a cache. In this case, the ECC process having higher error correction ability can be performed with respect to recording data on the hard disk rather than recording data in the flash memory.

The data writing sequence and data reading sequence are determined according to software stored in the controller 311. For example, when write data is transferred from the host device 100 to the hard disk 204, the data may be transferred via a path of host interface 202→controller 311→SDRAM interface 313→SDRAM 201→SDRAM interface 313→controller 311→disk interface 314→hard disk 204 or a path of host interface 202→controller 311→flash memory interface 315→flash memory 203→flash memory interface 315→controller 311→disk interface 314→hard disk 204. Further, the data can be transferred via a path of host interface 202→controller 311→flash memory interface 315→flash memory 203→flash memory interface 315→controller 311→SDRAM interface 313→SDRAM 201→SDRAM interface 313→controller 311→disk interface 314→hard disk 204.

When data is read from the hard disk 204 to the host device 100, the data may be read via a path of disk interface 314→controller 311→SDRAM interface 313→SDRAM 201→SDRAM interface 313→controller 311→host interface 312→host device or a path of disk interface 314→controller 311→flash memory interface 315→flash memory 203→flash memory interface 315→controller 311→host interface 312→host device. Further, the data can be read via a path of disk interface 314→controller 311→flash memory interface 315→flash memory 203→flash memory interface 315→controller 311→SDRAM interface 313→SDRAM 201→SDRAM interface 313→controller 311→host interface 312→host device.

<Explanation for Flash Memory>

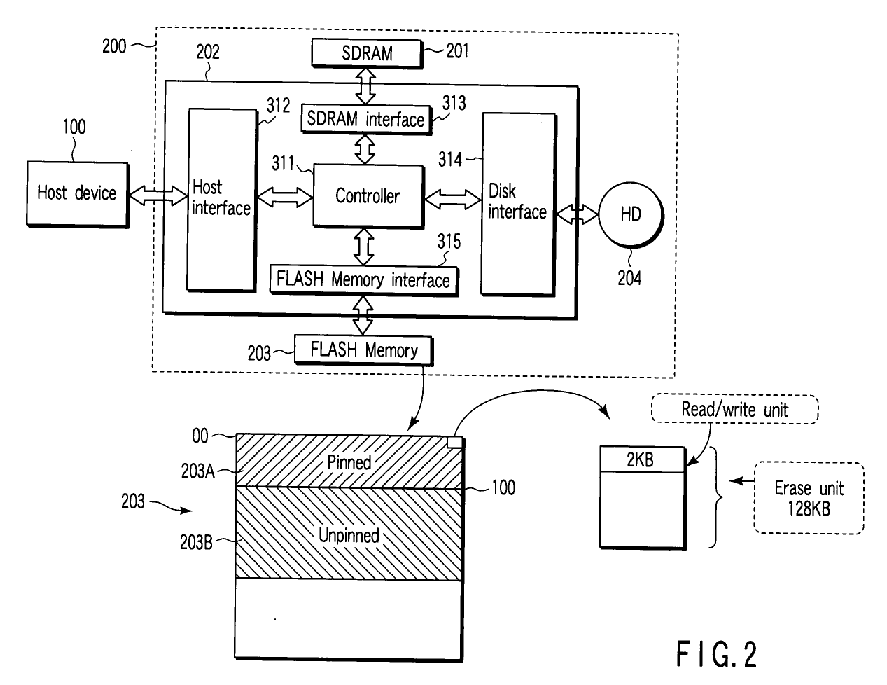

FIG. 2 is a diagram for illustrating the peculiar control operation in dealing with the flash memory 203. The flash memory 203 is a nonvolatile memory, but data can be electrically erased. Therefore, it is a data rewritable nonvolatile memory.

For example, the erase unit of the flash memory 203 is specified by 128 Kbytes. Further, the read unit and write unit are each specified by 2 Kbytes, for example. The elements of the flash memory 203 are degraded and the number of errors increases with an increase in the number of erasing operations. Therefore, as information which ensures the performance of the element, the number of rewriting times is specified to approximately 100,000 times. The number of bytes of the erase unit and the number of bytes of the write unit are not limited to the above values. For example, the erase unit may be set to 23 Kbytes and the read/write unit may be set to 512 bytes.

<Basic Relation Between Flash Memory, Controller and Command from Host Device>

As shown in FIG. 2, when data is written to the flash memory 203, the write area can be divided into areas which are called a Pinned area 203A and Unpinned area 203B. The Pinned area 203A is an area which is formed when a data write destination-indicating command supplied from the host device 100 specifies the flash memory 203. The command contains a logical block address (LBA) of the flash memory 203. The Unpinned area 203B is an area which is formed when a data write destination-indicating command from the host device 100 is not specified and in which data is transferred and stored according to independent determination by the controller 311.

As data to be written to the flash memory 203, data supplied from the host device 100 or data read from the hard disk 204 is provided.

Various types of determination conditions for determining a data write destination by the controller 311 are provided. The state determining section of the controller 311 synthetically judges the conditions of the surroundings and determines the write destination. For example, the condition is set in a state which occurs immediately after the power supply of the device is turned on and when the hard disk 204 does not reach a preset rotation speed or when the hard disk 204 is set in the stop state.

<Function and Configuration of Flash Memory Interface 315 and Controller 311>

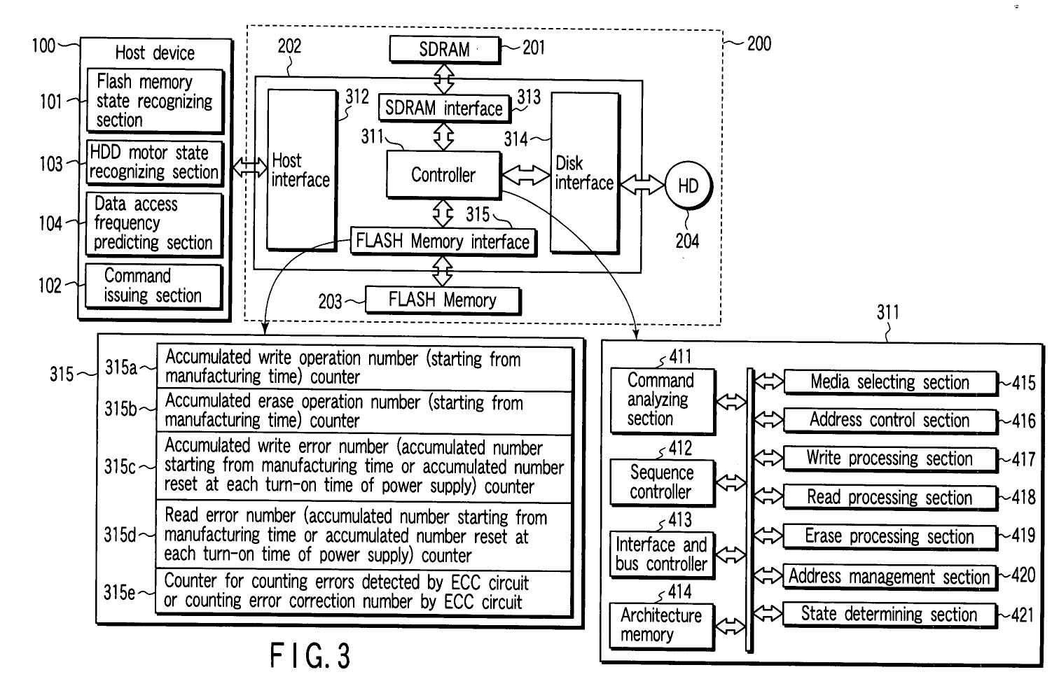

FIG. 3 shows the configurations of the controller 311 and flash memory interface 315 classified according to respective functions. An accumulation counter is provided in the flash memory interface 315, the count value thereof is written into a register provided in the interface, for example, and then written to the flash memory 203 or the flash memory 203 may be directly utilized.

As the counter, an accumulated write operation number counter 315a, accumulated erase operation number counter 315b, accumulated write error number counter 315c and read error number counter 315d are provided. Instead of the read error number counter 315d, an error number counter for counting errors detected by an ECC circuit or an error correction number counter 315e can be provided. Further, a counter which counts the read/write unit can be provided. The contents of the above counters are used as the determination factors of the state determining section which determines whether or not warning is issued when the number of errors becomes larger.

The controller 311 includes a command analyzing section 411 to decode and analyze a command supplied from the host device 100. It specifies software in an architecture memory 414 based on the analysis result of the command and sets an operation sequence in a sequence controller 412. Further, the command analyzing and control operation can be performed in the interface 312.

The sequence controller 412 controls the flow of data and control data via an interface and bus controller 413. For example, when the data write or read operation is performed, a media selecting section 415 specifies a flash memory 203 or hard disk (HD) 204 and an address control section 416 specifies a write address or read address. Then, at the data write time, a write processing section 417 performs a write data transfer process or the like. Further, at the data read time, a read processing section 418 performs a read data transfer process or the like.

In addition, an erase processing section 419 is provided. The erase processing section 419 performs the erase process for data of the flash memory 203. Further, the erase processing section 419 can perform the erase process for data of the hard disk.

An address management section 420 is provided. The address management section 420 collectively manages addresses of the hard disk 204 and addresses of the recorded area and unrecorded area of the flash memory 203. Since the flash memory 203 is used as a cache memory, it is unnecessary to pay attention to the address of the cache memory and set the address of the hard disk 204 side when the host device 100 side specifies the address. When a cache memory is specifically specified as a data storage destination, a Pinned command may be issued. If a Pinned command is not provided, the data storage destination is determined depending on the determination result of the firmware configured in the controller 311.

The address management and control operation for the Pinned area and Unpinned area of the flash memory 203 may be performed in the flash memory interface 315.

Further, a state determining section 421 is provided. The state determining section 421 monitors the state of the hard disk 204.

When the storage capacity of the flash memory 203 becomes larger than a certain threshold value, the controller 311 determines the state and performs a process of transferring and writing data on the hard disk 204. The operation performed at this time is mainly controlled by a combination of the read processing section 418, write processing section 416 and address management section 420.

A flash memory state recognizing section 101 which fetches the contents of a counter held in the flash memory interface 315 to monitor the state of the flash memory is provided in the host device 100. Further, the host device 100 includes a command issuing section 102, HDD motor state recognizing section 103 and data access frequency predicting section 104. The HDD motor state recognizing section 103 can predict whether or not the HDD motor is now rotated according to the issued command. For example, it is ensured that the HDD motor is rotated if a command which triggers the HDD and prepares the data write operation has been issued. Further, it is possible to predict that the HDD motor is stopped if a command which stops the HDD motor has been issued. The data access frequency predicting section 104 can determine whether the access frequency is high or low according to the object and contents of data transferred to the storage device 311. For example, if data indicating a set scene which is less frequently changed is used, the access frequency may be low. Further, if text data which is sequentially rewritten is used, the access frequency may be high. The controller of the host device 100 determines whether or not it is preferable to forcibly set the data write destination to the HDD according to the state of the flash memory and the data access frequency.

<Peculiar Configuration, Function and Operation in Present Embodiment>

<Basic Preposition> It is preferable to attain low power consumption in the above storage device. In order to attain this, the operation may preferably be managed to set the number of driving operations of the hard disk 204 as small as possible. If the management operation is performed to serve the above purpose, the number of accesses to the flash memory 203 will increase. If the management operation is performed to increase the number of write operations with respect to the flash memory 203, then there occurs a new problem that the service life of the flash memory 203 is shortened.

<Basic Solving Measure> Therefore, in the present embodiment, the operation management is performed to suppress the service life of the flash memory 203 from being shortened while an attempt is made to lower the power consumption. At the same time, the host device can forcibly control the storage destination of data and the reliability of the data process can be enhanced according to the state of the nonvolatile memory and data access frequency by use of means for responding to a command which specifies the write destination.

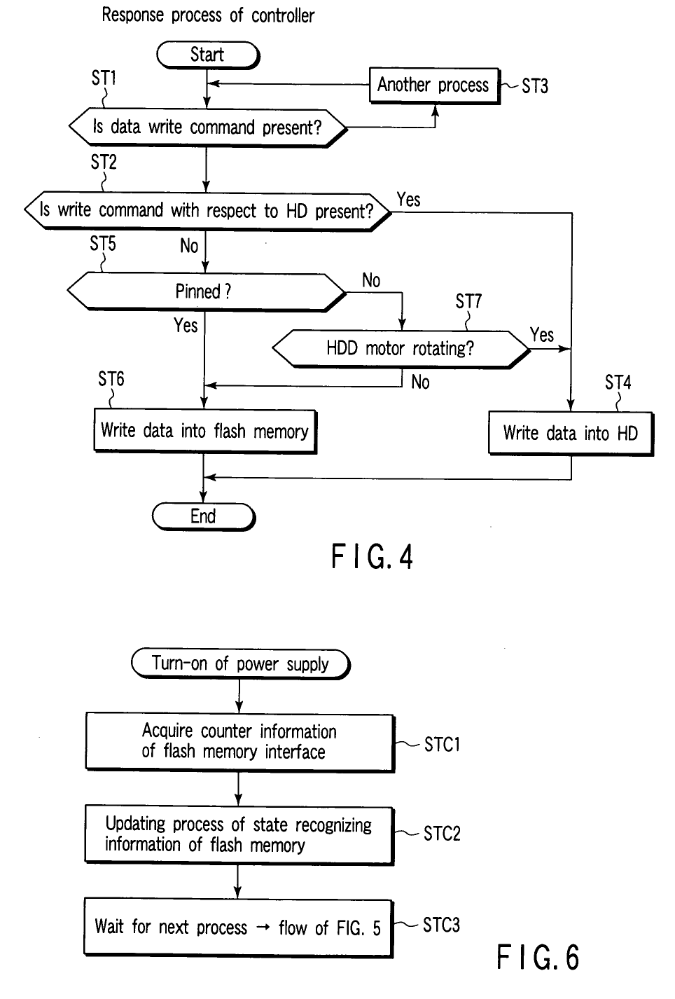

FIG. 4 is one example of a flowchart for illustrating the operation when the device performs the data writing process. The command analyzing section 411 analyzes a command supplied from the host device 100 and determines whether a data write command is provided or not (step ST1). If no data write command is provided, another process is performed (step ST3) and the process returns to step ST1.

If a data write command is provided, whether the hard disk 204 is specified as a data write destination or not is determined (step ST2). If the hard disk 204 is specified, write data is supplied to the hard disk 204 (step ST4).

If it is determined in step ST2 that the hard disk 204 is not specified, whether write data is Pinned data or not is determined (step ST5). If the write data is Pinned data, the write processing section 418 writes data to the flash memory 203. If the write data is not Pinned data, whether the hard disk drive (HDD) motor (spindle motor) is rotated or not is determined by the state determining section 421 (step ST7). If the spindle motor is not rotated, the write processing section 418 writes write data (corresponding to an Unpinned area) to the flash memory (step ST6). If the HDD motor is rotated, the write processing section 418 writes write data on the hard disk 204 (step ST4). As the determining condition for permitting data to be written on the hard disk (HD), whether the service life of the flash memory 203 comes close to the end or not is determined and if the service life comes close to the end, data may be written on the hard disk 204.

<Effective Influence>

By performing the above management operation, the access speed of the data process can be enhanced and the data reliability can be enhanced. Further, the number of new drive operations of the hard disk 204 can be set as small as possible. Therefore, the low power consumption can be attained. In addition, the number of accesses to the flash memory 203 can be suppressed. As a result, the service life of the flash memory 203 can be made longer.

<Peculiar Environment Coped with in Present Embodiment>

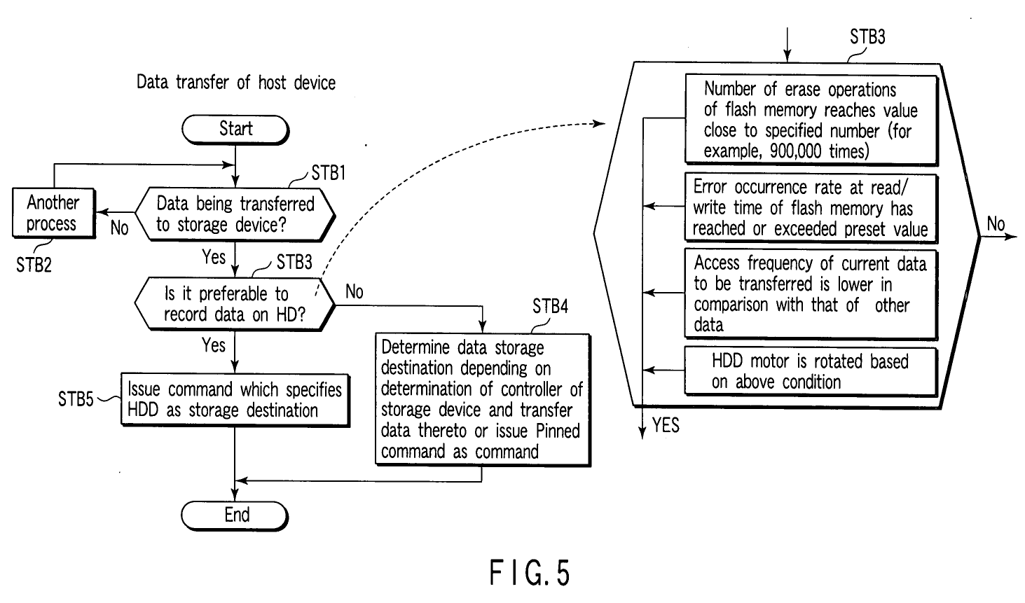

FIG. 5 is a flowchart for illustrating the operation and function of the host device 100. If it is determined that data is supplied to the storage device 200 (step STB1), whether a command which specifies the data to be stored in the HD should be issued or not is determined (step STB3). Various determination conditions are provided, but they will be described later. If it is concluded that data should be held in the hard disk 204, a command which specifies the hard disk 204 as a storage destination is issued, then data is transferred and the process is terminated (step STB5). If the conclusion indicating that data should be held in the hard disk 204 cannot be obtained in step STB3, the data storage destination is determined depending on determination of the controller of the storage device 200 (step STB4). Alternatively, if it is concluded that data should be held in the flash memory 315, a Pinned command described before is issued as a command.

Some of the above determination conditions are described below. For example, (1) the number of erase operations of the flash memory is set to a value close to a specified number (for example, 900,000 times). (2) The error occurrence rate at the read/write time of the flash memory becomes equal to or higher than a preset value. The preset value is set by a maker itself or according to the specification of the memory. (3) The access frequency of current data output from the host device is lower in comparison with that of other data. (4) At least one of the above conditions is satisfied and the spindle motor is rotated.

FIG. 6 briefly shows the operation when the power supply of the device of the present embodiment is turned on. When the power supply of the device is turned on, the host device 100 acquires information stored in the counter of the flash memory interface 315 (step STC1). Then, in the state recognizing section 101 of the flash memory shown in FIG. 3, the information updating process is performed (step STC2) and the host device is set in a standby state for a next process (step STC3). As a result, the counter information is updated to the newest information when the power supply is turned on.

As described above, since the host side can forcibly control the data storage destination according to the state of the nonvolatile memory or data access frequency by use of means for responding to a command which specifies a write destination, the high-speed read/write operation and lower power consumption can be attained, the service life of the storage medium can be made longer and the reliability of the data process can be enhanced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device using a nonvolatile cache memory, comprising:
a host interface,
a memory interface acting as an interface with respect to a cache memory,
a command analyzing section which analyzes contents of a command input from the host interface, and
a write processing section which transfers write data to a hard disk when a command analyzed by the command analyzing section specifies the hard disk as a data write destination, and transfers the write data to the cache memory when the command specifies a Pinned area.

2. The storage device using the nonvolatile cache memory according to claim 1, which further comprises a state determining section which determines a rotation state of the hard disk when the command analyzed by the command analyzing section does not specify the hard disk as the data write destination and in which the write processing section transfers the write data to the hard disk when the determination result of the state determining section indicates that the hard disk is rotated and transfers the write data to the cache memory when the determination result indicates that the hard disk is not rotated.

3. The storage device using the nonvolatile cache memory according to claim 1, wherein the cache memory is a flash memory.

4. A storage device using a nonvolatile cache memory, comprising:
a host device which issues a command,
a host interface connected to the host device,
a memory interface acting as an interface with respect to a cache memory,
a command analyzing section which analyzes contents of a command input from the host interface, and
a write processing section which transfers write data to a hard disk when a command analyzed by the command analyzing section specifies the hard disk as a data write destination and transfers the write data to the cache memory when the command specifies a Pinned area.

5. The storage device using the nonvolatile cache memory according to claim 4, wherein the host device includes a data access frequency predicting section and issues a command which specifies the hard disk as the data write destination when it is determined that access frequency of the write data is low.

6. The storage device using the nonvolatile cache memory according to claim 4, wherein the host device includes a state recognizing section which recognizes a state of the cache memory and issues a command which specifies the hard disk as the data write destination when the number of erase operations of the cache memory reaches a preset value.

7. The storage device using the nonvolatile cache memory according to claim 4, wherein the host device includes a state recognizing section which recognizes an error occurrence state of the cache memory and issues a command which specifies the hard disk as the data write destination when an error occurrence rate exceeds a preset value.

8. A control method for a storage device which includes a host interface, a memory interface acting as an interface with respect to a cache memory and a command analyzing section which analyzes contents of a command input from the host interface and makes data access to a hard disk and the cache memory, comprising:
transferring write data to the hard disk when a command analyzed by the command analyzing section specifies the hard disk as a data write destination, and
transferring the write data to the cache memory when the command specifies a Pinned area.

9. The control method for the storage device according to claim 8, further comprising determining a rotation state of the hard disk when the command analyzed by the command analyzing section does not specify the hard disk as the data write destination, transferring the write data to the hard disk when the state determination result indicates that the hard disk is rotated, and transferring the write data to the cache memory when the state determination result indicates that the hard disk is not rotated.

10. The control method for the storage device according to claim 8, wherein the host device which issues the command includes a data access frequency predicting section and issues a command which specifies the hard disk as the data write destination when it is determined that access frequency of the write data is low.

11. The control method for the storage device according to claim 8, wherein the host device which issues the command includes a state recognizing section which recognizes a state of the cache memory and issues a command which specifies the hard disk as the data write destination when the number of erase operations of the cache memory reaches a preset value.

12. The control method for the storage device according to claim 8, wherein the host device which issues the command includes a state recognizing section which recognizes an error occurrence state of the cache memory and issues a command which specifies the hard disk as the data write destination when an error occurrence rate exceeds a preset value.
